(19) United States
(12) Patent Application Publication
(10) Pub. No.: US 2018/0327603 A1
(43) Pub. Date: Nov. 15, 2018

(54) ANTHRAQUINONE COMPOUNDS AND USE THEREOF

(71) Applicant: INDUSTRIAL TECHNOLOGY RESEARCH INSTITUTE, Hsinchu (TW)

(72) Inventors: Min-Yan DONG, Fuxing Township (TW); Wen-Hsien WANG, Tainan City (TW); Chin-Heng TIEN, Miaoli City (TW); Jing-Wen TANG, Hsinchu City (TW); Tzong-Ming LEE, Hsinchu City (TW)

(73) Assignee: INDUSTRIAL TECHNOLOGY RESEARCH INSTITUTE, Hsinchu (TW)

(21) Appl. No.: 15/715,483

(22) Filed: Sep. 26, 2017

(30) Foreign Application Priority Data
May 10, 2017 (TW) 106115431

(51) Int. Cl. C09B 1/28

(52) U.S. Cl. CPC C09B 1/285

(57) ABSTRACT

An anthraquinone compound is provided. The anthraquinone compound has the following formula (I):

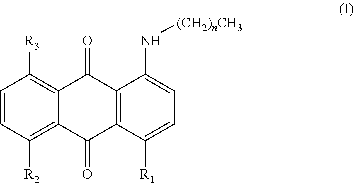

wherein one of R₁, R₂, and R₃ is —NH—(CH₂)ₘ—CH₃, and the other two are each independently selected from hydrogen or C₁₋₄ alkyl group; and n and m are each independently an integer from 4 to 17.

### CROSS REFERENCE TO RELATED APPLICATIONS

This application claims priority of Taiwan Patent Application No. 106115431, filed on May 10, 2017, the entirety of which is incorporated by reference herein.

### TECHNICAL FIELD

The present disclosure relates to an anthraquinone compound and the use of the anthraquinone compound as dyes.

### BACKGROUND

Supercritical fluid dyeing (SFD) is a new eco-friendly dyeing technique. International manufacturers in the textile industry have put great effort in the development of the SFD process. However, dyeing products available for the SFD process are few. There are only 21 dyes for SFD, and the black dye is still in the experimental stage. Therefore, the color matching of fabric in SFD is quite difficult.

Moreover, there is currently only one SFD dye having the colorfastness to laundering up to Grade 3.5 for polyurethane fiber and the blended fabrics thereof. Therefore, the industry is in desperate need of usable SFD dyes.

### SUMMARY

In accordance with some embodiments of the disclosure, an anthraquinone compound is provided. The anthraquinone compound has the structure of the following formula (I):

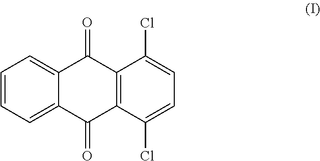 [SMILES: O=C1c2ccccc2C(=O)c2c(Cl)ccc(Cl)c21]

wherein one of R₁, R₂ and R₃ is —NH—(CH₂)ₘ—CH₃, and the other two are each independently selected from hydrogen (H) or C₁₋₄ alkyl group; and n and m are each independently an integer from 4 to 17

In accordance with some embodiments of the disclosure, a use of an anthraquinone compound as dyes is provided. The anthraquinone compound has the structure of the following formula (I):

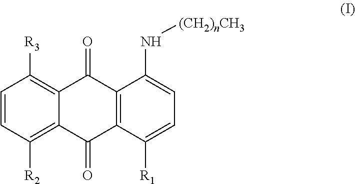

wherein one of R₁, R₂ and R₃ is —NH—(CH₂)ₘ—CH₃, and the other two are each independently selected from hydrogen or C₁₋₄ alkyl group; and n and m are each independently an integer from 4 to 17.

The present disclosure is best understood with reference to the detailed description set forth herein. Various embodiments are discussed below.

### DETAILED DESCRIPTION

The anthraquinone compound of the present disclosure is described in detail in the following description. In the following detailed description, for purposes of explanation, numerous specific details and embodiments are set forth in order to provide a thorough understanding of the present disclosure. The specific elements and components described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments.

In accordance with an embodiment of the present disclosure, an anthraquinone compound is provided. The anthraquinone compound has the structure of the following formula (I):

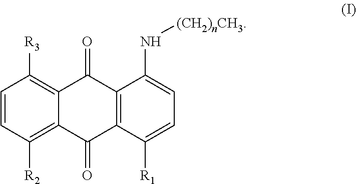

In formula (I), one of R₁, R₂ and R₃ is —NH—(CH₂)ₘ—CH₃, and the other two are each independently selected from hydrogen or C₁₋₄ alkyl group; and n and m are each independently an integer from 4 to 17.

In some embodiments of the present disclosure, the anthraquinone compound may be

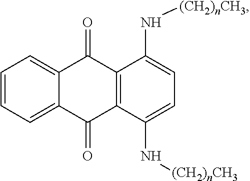

wherein each n is independently an integer from 4 to 17.

In some embodiments of the present disclosure, the anthraquinone compound may be

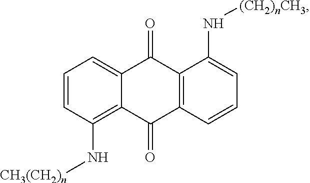

wherein each n is independently an integer from 4 to 17.

In some embodiments of the present disclosure, the anthraquinone compound may be

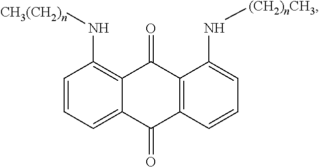

wherein each n is independently an integer from 4 to 17.

In some embodiments of the present disclosure, the anthraquinone compound may be

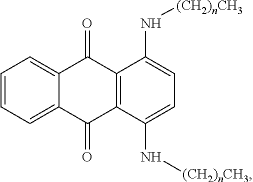

wherein each n is independently an integer from 7 to 17.

In some embodiments of the present disclosure, the anthraquinone compound may be

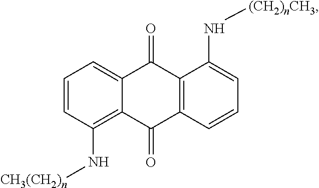

wherein each n is independently an integer from 7 to 17.

In some embodiments of the present disclosure, the anthraquinone compound may be

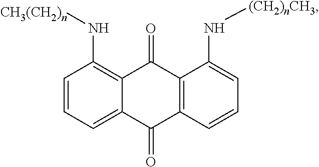

wherein each n is independently an integer from 7 to 17.

In some embodiments of the present disclosure, the anthraquinone compound may be

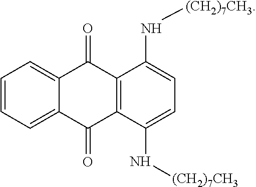

In some embodiments of the present disclosure, the anthraquinone compound may be

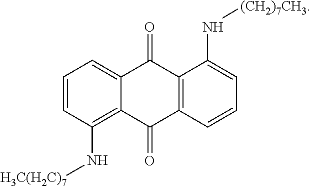

In some embodiments of the present disclosure, the anthraquinone compound may be

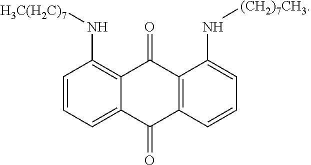

In accordance with an embodiment of the present disclosure, a use of an anthraquinone compound as dyes is provided. The anthraquinone compound has the structure of the following formula (I):

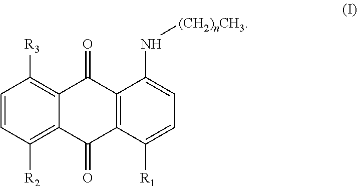

In formula (I), one of R₁, R₂ and R₃ is —NH—(CH₂)ₘ—CH₃, and the other two are each independently selected from hydrogen or C₁₋₄ alkyl group; and n and m are each independently an integer from 4 to 17.

In some embodiments of the present disclosure, the anthraquinone compound serving as dyes may be

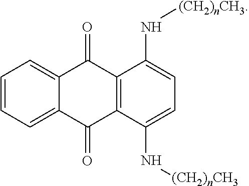

wherein each n is independently an integer from 4 to 17.

In some embodiments of the present disclosure, the anthraquinone compound serving as dyes may be

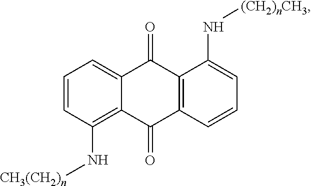

wherein each n is independently an integer from 4 to 17.

In some embodiments of the present disclosure, the anthraquinone compound serving as dyes may be

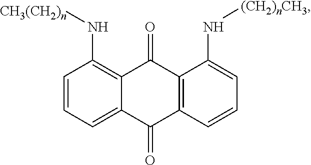

wherein each n is independently an integer from 4 to 17.

The making and using of the embodiments of the disclosure are discussed in detail below. It should be appreciated that the specific embodiments discussed are merely illustrative, and do not limit the scope of the disclosure.

### Example 1

### Synthesis of the Anthraquinone Compound A of the Present Disclosure

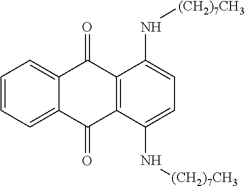

In this example, 11.104 g of 1, 4-dichloroanthroquinone (0.04 mol), 11.885 g of 1-octylamine (0.088 mol) and 2.770 g of potassium carbonate (0.02 mol) were placed in a double neck bottle, and 60 ml of 1-butanol were added. The mixture was stirred under vacuum for 60 seconds to remove oxygen and water vapor. Then, the mixture was heated to reflux under nitrogen condition for 24 hours (the color of the mixture was yellow at the beginning of the reaction, and turned blue-purple after reflux was performed for about 1 hour). After the reacted mixture was cooled down to room temperature, 50 ml of acetone was added. The mixture was placed in an ultrasonic vibrator for dissolution for about 30 minutes, and then was subjected to filtration. The solid in the upper layer was washed with acetone 3-4 times. Thereafter, the blue filtrate in the lower layer was concentrated to remove acetone, and 100 g of ethyl acetate (EAc) was added and stirred at 50° C. Then, the filtrate was purified by recrystallization and was dried. 5.67 g of blue powder crystal product (the anthraquinone compound A) was obtained. The yield was 61.27%. The above reaction formula is shown below:

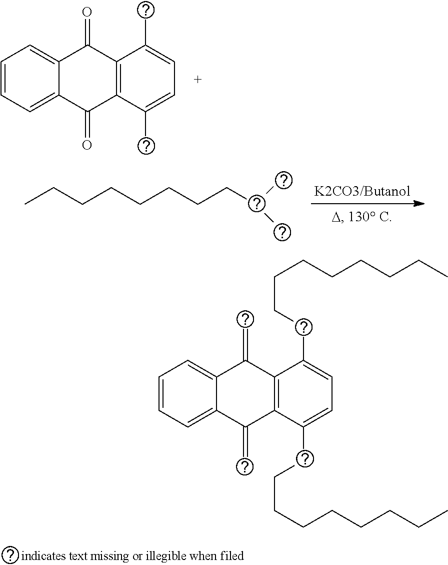

The anthraquinone compound A was analyzed by nuclear magnetic resonance (NMR) spectroscopy. The information of the obtained NMR spectrum is shown below: ¹H-NMR (300 MHz, CDCl₃, 294 K): d/ppm 0.86-0.92 (m, 6H), 1.20-1.42 (m, 16H), 1.45-1.56 (m, 4H), 1.78 (q, 4H), 3.35-3.47 (s, 4H), 7.30 (s, 2H), 7.68-7.78 (m, 2H), 8.33-8.41 (m, 2H), 10.87 (s, 2H).

### Example 2

### Synthesis of the Anthraquinone Compound B of the Present Disclosure

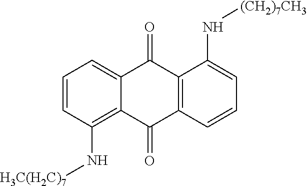

In this example, 11.076 g of 1, 5-dichloroanthroquinone (0.04 mol), 11.363 g of 1-octylamine (0.088 mol) and 2.789 g of potassium carbonate (0.02 mol) were placed in a double neck bottle, and 60 ml of 1-butanol were added. The mixture was stirred under vacuum for 60 seconds to remove oxygen and water vapor. Then, the mixture was heated to reflux under nitrogen condition for 8 hours (the color of the mixture was yellow at the beginning of the reaction, and turned red after reflux was performed for about 1 hour). After the reacted mixture was cooled down to room temperature, 50 ml of acetone was added. The mixture was placed in an ultrasonic vibrator for dissolution for about 30 minutes, and then was subjected to filtration. The solid in the upper layer was washed with acetone 3-4 times. Thereafter, the red filtrate in the lower layer was concentrated to remove acetone, and 100 g of ethyl acetate (EAc) was added and stirred at 50° C. Then, the filtrate was purified by recrystallization and was dried. 6.42 g of blue powder crystal product (the anthraquinone compound B) was obtained. The yield was 69.0%. The above reaction formula is shown below:

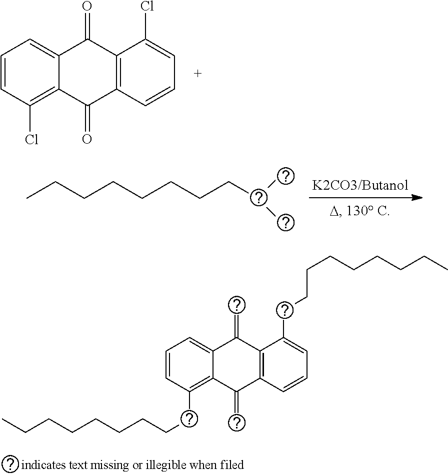

The anthraquinone compound B was analyzed by nuclear magnetic resonance (NMR) spectroscopy. The information of the obtained NMR spectrum is shown below: ¹H-NMR (300 MHz, CDCl₃, 294 K): d/ppm 0.86-0.92 (m, 6H), 1.20-1.42 (m, 16H), 1.45-1.56 (m, 4H), 1.78 (q, 4H), 3.35-3.47 (s, 4H), 7.01 (d, 2H); 7.51 (d, 2H); 7.55 (t, 2H); 9.79 (d, 2H).

### Example 3

### Synthesis of the Anthraquinone Compound C of the Present Disclosure

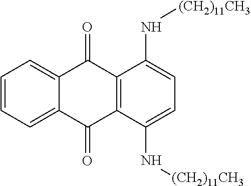

In this example, 11.084 g of 1, 4-dichloroanthroquinone (0.04 mol), 37.078 g of 1-dodecylamine (0.2 mol) and 2.760 g of potassium carbonate (0.02 mol) were placed in a double neck bottle, and 100 ml of 1-butanol were added. The mixture was stirred under vacuum for 60 seconds to remove oxygen and water vapor. Then, the mixture was heated to reflux under nitrogen condition for 24 hours (the color of the mixture was yellow at the beginning of the reaction, and turned blue-purple after reflux was performed for about 1 hour). The reaction mixture was blue semisolid after cooling down to room temperature. Then, the mixture was poured into 100 ml of alcohol (95%) for re-precipitation. The obtained blue solid precipitate was transferred into a one-neck bottle having a volume of 500 ml, and 200 ml of ethanol (ECHO, 95%) was added. The mixture was then heated to reflux for 1 hour. Thereafter, the mixture was filtered to remove insolubles while the temperature of the mixture was still high. The filtrate was left to stand at room temperature (about 24° C.) for recrystallization. The obtained blue solid crystal precipitate was subjected to suction filtration, and then was washed with 30 ml of cold alcohol (95%) twice. Thereafter, the obtained solid precipitate was transferred to a vacuum oven for drying under reduced pressure at 80° C. for 2 hours. 14.480 g of blue solid product (the anthraquinone compound C) was obtained. The yield was 63.0%. The melting point of the obtained product measured by DSC was 85.73° C.-86.58° C. The above reaction formula is shown below:

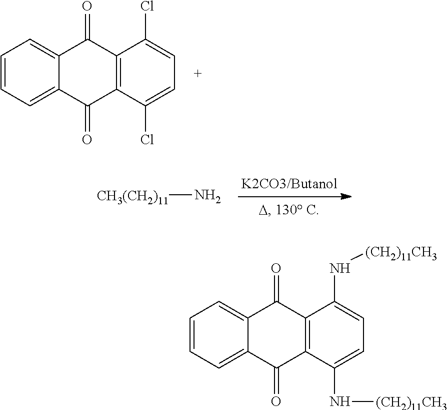

### Example 4

### Staining Evaluation for the Anthraquinone Compound A Used in Polyurethane/Polyester Fabrics

10 g of polyurethane/polyester fabric (T50D/72F/2 SD DTY+8% 30D OP/Eclat Co.) were placed in a high-pressure dyeing vessel having a volume of 300 ml. Then, 0.1 g of the dye product obtained in Example 1 (the anthraquinone compound A) was added into the high-pressure dyeing vessel, and 151.5±0.5 g of liquid CO₂ was injected into the high-pressure dyeing vessel. The temperature and the pressure of the high-pressure dyeing vessel were increased to 120° C. and 25 MPa respectively and then were maintained for 80 minutes, after the high-pressure dyeing vessel was coupled to the glycerol dyeing machine. Thereafter, liquid CO₂ was continuously injected into the high-pressure dyeing vessel from the external part, and a washing process was conducted for 50 minutes under the conditions of 120° C. and 250 bar. The temperature was decreased to 40° C. and the pressure was recovered to atmospheric pressure, after the washing process. Then, the obtained dyed fabric sample was taken out and subjected to the colorfastness to laundering test with a multifiber test fabric according to AATCC (the American Association of Textile Chemists and Colorists) 61 2A Evaluation Procedure.

150 ml of liquor containing 0.15% AATCC Standard Reference Detergents were placed in the stainless steel cylinder having the volume of 1200 ml (90 mm*200 mm), and the dyed fabric sample (50 mm*150 mm) and the multifiber test fabric (50 mm*100 mm) were placed in the stainless steel cylinder. Then, the stainless steel cylinder was fixed in a standard laundering machine and the standard washing process was run at 49° C. (±2° C.) for 45 minutes. The dyed fabric sample and the multifiber test fabric were taken out and placed in beakers. Each of them was rinsed three times with distilled or deionized water at 40±3° C. for 1 minute with occasional stirring or scrubbing. Thereafter, the dyed fabric sample and the multifiber test fabric were subjected to a centrifuge or a dewatering machine to remove excess water, and then were dried at a temperature of less than 71° C. in the oven.

Thereafter, a determination was made as to whether other fiber materials of the multifiber test fabric were stained by the dyes derived from the dyed fabric sample. According to the staining evaluation, the colorfastness to laundering of the dyes can be determined. Colorfastness to laundering of Grade 5 means negligible or no color transfer to the undyed multifiber test fabric. Colorfastness to laundering of Grade 1 means that the undyed multifiber test fabric was stained severely. The result of colorfastness to laundering test in Example 4 is shown in Table 1.

### Example 5

### Staining Evaluation for the Anthraquinone Compound a Used in Nylon Fabrics

10 g of nylon fabrics (N40D/34F/2 SD DTY/Eclat Co.) were placed in a high-pressure dyeing vessel having a volume of 300 ml. Then, 0.1 g of the dye product obtained in Example 1 (the anthraquinone compound A) was added into the high-pressure dyeing vessel, and 151.5±0.5 g of liquid CO₂ was injected into the high-pressure dyeing vessel. The temperature and the pressure of the high-pressure dyeing vessel were increased to 110° C. and 25 MPa respectively and then were maintained for 80 minutes, after the high-pressure dyeing vessel was coupled to the glycerol dyeing machine. Thereafter, liquid CO₂ was continuously injected into the high-pressure dyeing vessel from the external part, and a washing process was conducted for 50 minutes under the conditions of 110° C. and 250 bar. The temperature was decreased to 40° C. and the pressure was recovered to atmospheric pressure, after the washing process. Then, the obtained dyed fabric sample was taken out and subjected to the colorfastness to laundering test with a multifiber test fabric according to AATCC 61 2A Evaluation Procedure.

Thereafter, a determination was made as to whether other fiber materials of the multifiber test fabric were stained by the dyes derived from the dyed fabric sample (the steps were the same as those in Example 4). According to the staining evaluation, the colorfastness to laundering of the dyes can be determined. The result of colorfastness to laundering test in Example 5 is shown in Table 1.

### Example 6

### Staining Evaluation for the Anthraquinone Compound B Used in Polyurethane/Polyester Fabrics

The steps are substantially the same as those in Example 4, except that the dye product used is that obtained in Example 2 (the anthraquinone compound B). The result of colorfastness to laundering test in Example 6 is shown in Table 1.

### Example 7

### Staining Evaluation for the Anthraquinone Compound B Used in Nylon Fabrics

The steps are substantially the same as those in Example 5, except that the dye product used is that obtained in Example 2 (the anthraquinone compound B). The result of colorfastness to laundering test in Example 7 is shown in Table 1.

### Comparative Example 1

### Staining Evaluation for the Commercial Dye Blue-134 Used in Fabrics

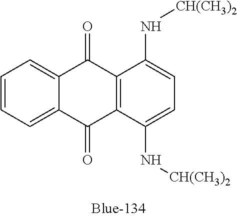 [SMILES: CC(C)Nc1ccc(NC(C)C)c2c1C(=O)c1ccccc1C2=O]

The steps are substantially the same as those in Example 4, except that the dye used is commercial dye Blue-134. The result of colorfastness to laundering test in Comparative Example 1 is shown in Table 1.

### Comparative Example 2

### Staining Evaluation for the Commercial Dye Blue-58 Used in Fabrics

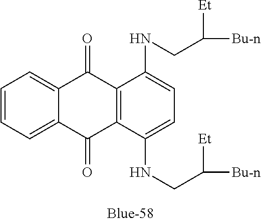

The steps are substantially the same as those in Example 4, except that the dye used is commercial dye Blue-58. The result of colorfastness to laundering test in Comparative Example 2 is shown in Table 1.

### Comparative Example 3

### Staining Evaluation for the Commercial Dye Blue-334 Used in Fabrics

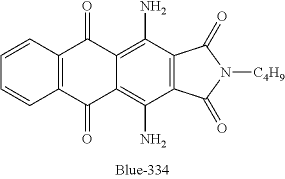

The steps are substantially the same as those in Example 4, except that the dye used is commercial dye Blue-334. The result of colorfastness to laundering test in Comparative Example 3 is shown in Table 1.

### Comparative Example 4

### Staining Evaluation for the Commercial Dye AQ-01 Used in Fabrics

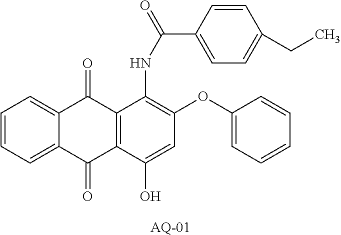

The steps are substantially the same as those in Example 4, except that the dye used is commercial dye AQ-01. The result of colorfastness to laundering test in Comparative Example 4 is shown in Table 1.

TABLE 1

| | Colorfastness to laundering according | | | | | |
|---|---|---|---|---|---|---|
| | to AATCC 2A Procedure (Grade) | | | | | |
| | wool | polyacrylate | PET | nylon | cotton | acetate |
| Example 4 | 4.0 | 4.5 | 4.0 | 3.5 | 4.0 | 4.0 |
| (anthraquinone | | | | | | |
| compound A) | | | | | | |
| Example 5 | 4.0 | 4.5 | 4.0 | 4.0 | 4.0 | 4.0 |
| (anthraquinone | | | | | | |
| compound A) | | | | | | |
| Example 6 | 4.0 | 4.5 | 4.0 | 3.5 | 4.0 | 4.0 |
| (anthraquinone | | | | | | |
| compound B) | | | | | | |
| Example 7 | 4.0 | 4.5 | 4.0 | 4.0 | 4.0 | 4.0 |
| (anthraquinone | | | | | | |
| compound B) | | | | | | |
| Comparative | 4.0 | 3.5 | 4.0 | 3.0 | 4.5 | 2.5 |
| Example 1 | | | | | | |
| (Blue-134) | | | | | | |
| Comparative | 4.0 | 4.0 | 4.0 | 3.0 | 4.5 | 3.5 |
| Example 2 | | | | | | |
| (Blue-58) | | | | | | |
| Comparative | 4.0 | 4.0 | 4.0 | 3.0 | 4.0 | 3.5 |
| Example 3 | | | | | | |
| (Blue-334) | | | | | | |
| Comparative | 4.0 | 4.5 | 4.0 | 3.5 | 4.0 | 3.5 |
| Example 4 | | | | | | |
| (AQ-01) | | | | | | |

In accordance with some embodiments of the present disclosure, the anthraquinone compounds used in polyester fabrics and the blended fabrics thereof may have colorfastness to laundering of Grade 3.5 or more.

Although some embodiments of the present disclosure and their advantages have been described in detail, it should be understood that various changes, substitutions and alterations can be made herein without departing from the spirit and scope of the disclosure as defined by the appended claims. For example, it will be readily understood by one of ordinary skill in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An anthraquinone compound having the following structure: 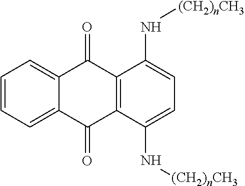
wherein each n is independently an integer from 4 to 6.

2-7. (canceled)

8. A method of using an anthraquinone compound for staining a fabric, comprising:
subjecting the fabric to the anthraquinone compound,
wherein the anthraquinone compound has the following structure: 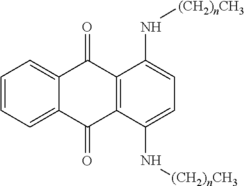
wherein n is independently an integer from 4 to 6.

9-11. (canceled)
